(19) United States
(12) Patent Application Publication
(10) Pub. No.: US 2010/0101134 A1
(43) Pub. Date: Apr. 29, 2010

(54) CLEANING TOOL FOR FISHING DEVICES

(76) Inventor: Robert Bosley, Duncan, OK (US)

Correspondence Address: DUNLAP CODDING, P.C., PO BOX 16370, OKLAHOMA CITY, OK, 73113, US

(21) Appl. No.: 12/325,738

(22) Filed: Dec. 1, 2008

Related U.S. Application Data
(60) Provisional application No. 60/991,117, filed on Nov. 29, 2007.

(51) Int. Cl. A01K 97/06; A01K 97/00

(52) U.S. Cl. 43/1; 43/25.2; 43/57.1

(57) ABSTRACT

A cleaning tool for fishing lures having a connector member and a cleaning member wherein when a fishing lure is brought into contact with the cleaning member, the cleaning member removes debris disposed on the fishing lure.

### CROSS-REFERENCE TO RELATED APPLICATIONS

This application claims the benefit of U.S. Provisional Application Ser. No. 60/991,117, filed Nov. 29, 2007, the contents of which is hereby incorporated herein by reference.

### BACKGROUND OF THE INVENTION

1. Field of the Invention

This invention relates to the cleaning of various types of devices that gather debris from use in water that have sharp edges, hooks, or mechanical parts that rotate, swivel, bend or move. Specifically, this device is used to clean equipment that is used as artificial bait in attracting and catching fish. This apparatus will be installed on various types of fishing rods by connecting each member of the apparatus to each other around and over the rod nut or frontal cork of a rod handle.

2. Brief Description of Related Art

Most often, when fishing, there is use of a rod and reel, with the rod normally of the type that is fabricated of several components consisting of a tubular rod with eyelets that allow for a fishing line to be threaded for connection with a swivel, hook, bait or lure to engage in fishing. There are numerous problems that need to be addressed during fishing in order to maintain the proper performance, ease of use, and capability of the lure to catch fish. Several of the more common problems are listed below.

First, when fishing in shallow water of lakes and ponds, fishing lures and hooks will collect moss and various other debris during the normal casting and retrieval/reeling in of the bait. This debris prevents proper operation of the lure in the water which severely impedes the ability to catch fish. Further complications occur when removing this debris as most often this debris has to be removed with your fingers which is a difficult task in small hard to reach moving parts such as swivels, fans, and other mechanical parts of the artificial bait. And worse, removal of debris that is lodged tightly around skirts and hooks creates a safety hazard due to a high risk of a hook pricking your hand or finger when exerting force to remove the debris.

The second problem one faces is the more time that is required to clean the artificial baits, the less fishing time for bait to be in the water which severely reduces the opportunity to catch fish.

The third problem when fishing is storage of the lure while transporting the rod with the artificial bait attached to the end of the line when moving to a different location by hand or in the boat. This problem is created when the artificial bait hooks is engaged in the eyelet of the rod or stuck in the cork handle of the rod. The first problem is that repeated friction from constant rubbing of metal hooks on metal eyelets will eventually cause a chip in the eyelet of the rod. Due to the fact that the majority of fishing is conducted outdoors in and around water, the chip will rust and the subsequent rough serrated edge of the rusted eyelet will cut the fishing line when the line is taut from a hooked fish which results in the loss of fish and all fishing tackle. Complete re-threading of the line with additional tackle is required to continue to fish which results in lost fishing time and reduced opportunity to catch fish.

Additionally, when transporting the fishing rod with fishing lures attached to the end of the line and hooked is the eyelet, there is a propensity for the hook to dislodge from the eyelet. Once dislodged, the hooks can cause the potential for injury as the hooks may inadvertently stick your hands or catch on other surrounding elements (edges in the boat, tree limbs or bushes) and snap back with force which could result in serious injury.

The present invention is directed to a cleaning tool that is suitable for installation on typical surfaces of all fishing rods that includes a connector strap constructed of a sufficient length of bond material that is used to connect to the fishing rod by securing tightly over the rod nut or front cork of the rod handle and connected to a second surface that is a lower cleaning strap which is constructed of a specified length of bond material. The connector strap surface is printed with an ink that glows in the dark.

An object of this invention is to use the hook surface of the cleaning strap along with the rod in a brushing fashion to remove debris from various types of artificial fishing bait. Or, artificial bait can be rubbed on the hook surface of the cleaning strap with the hand and the debris will be removed.

It is a further object of the invention to be able to quickly locate the tool and clean the lure when fishing at night with insufficient light using the illumination from the “glow-in-the-dark” ink.

It is a further object of the invention to cover hooks by inserting the lure hooks between the loop surface of the connector strap and pinching the side of the lower cleaning strap together. This will lock in the hooks and prevent them from dislodging.

It is a further object of the invention to prevent chipping and corrosion of the eyelets and subsequent cutting of the fishing line by using the connector strap to cover hooks by insert the lure hooks between the hook surface of the connector strap and pinching the side of the lower cleaning strap together to prevent them from dislodging.

It is a further object of the present invention to provide a cleaning tool that is simply manufactured and is of low cost and can be affordable for most people who practice the art of fishing.

It is a further object of the invention to secure the cleaning tool at any location along the rod that is desired by the user.

### BRIEF DESCRIPTION OF THE SEVERAL VIEWS OF THE DRAWINGS

FIG. 1 is an exploded, perspective view of a cleaning tool constructed in accordance with the present invention.

FIG. 2 is a perspective view of the cleaning tool of the present invention.

FIG. 3 shows the cleaning tool attached to a fishing rod and being used to clean debris from a fishing lure.

FIG. 4 illustrates the cleaning tool being used to secure a fishing lure to the fishing rod.

FIG. 5 illustrates the cleaning tool being used to hold a fishing hook.

FIG. 6 illustrates the cleaning tool being used to secure fishing rods to one another.

### DETAILED DESCRIPTION OF EXEMPLARY EMBODIMENT

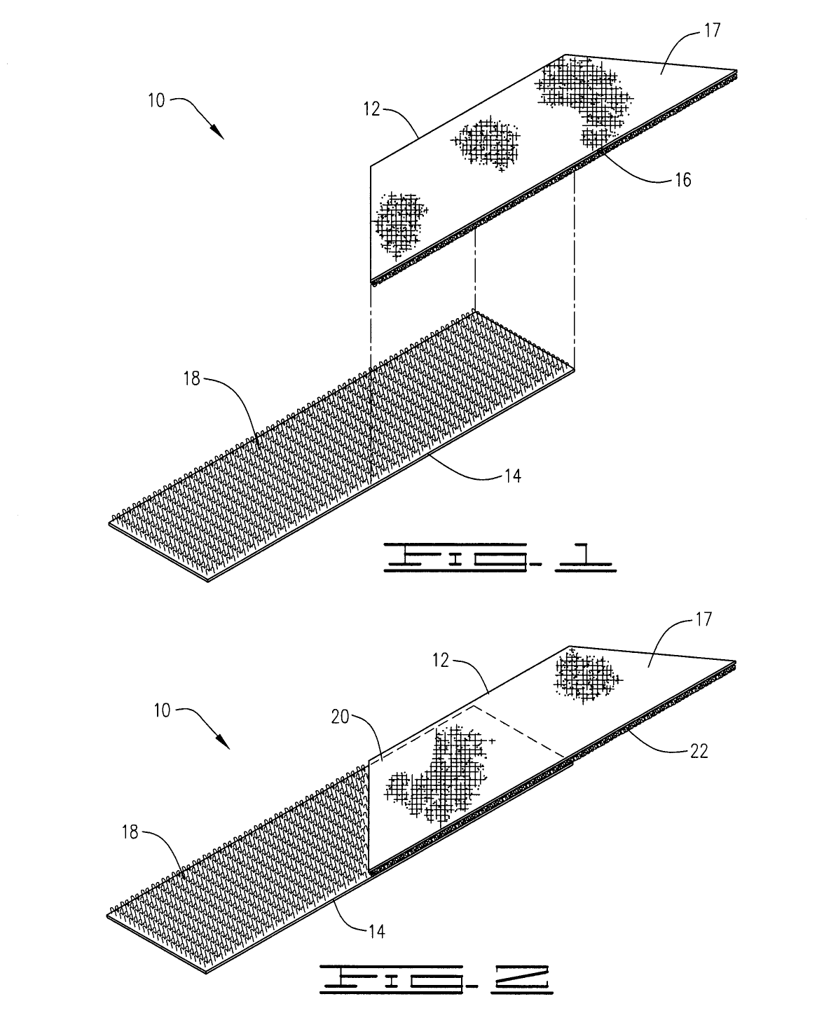

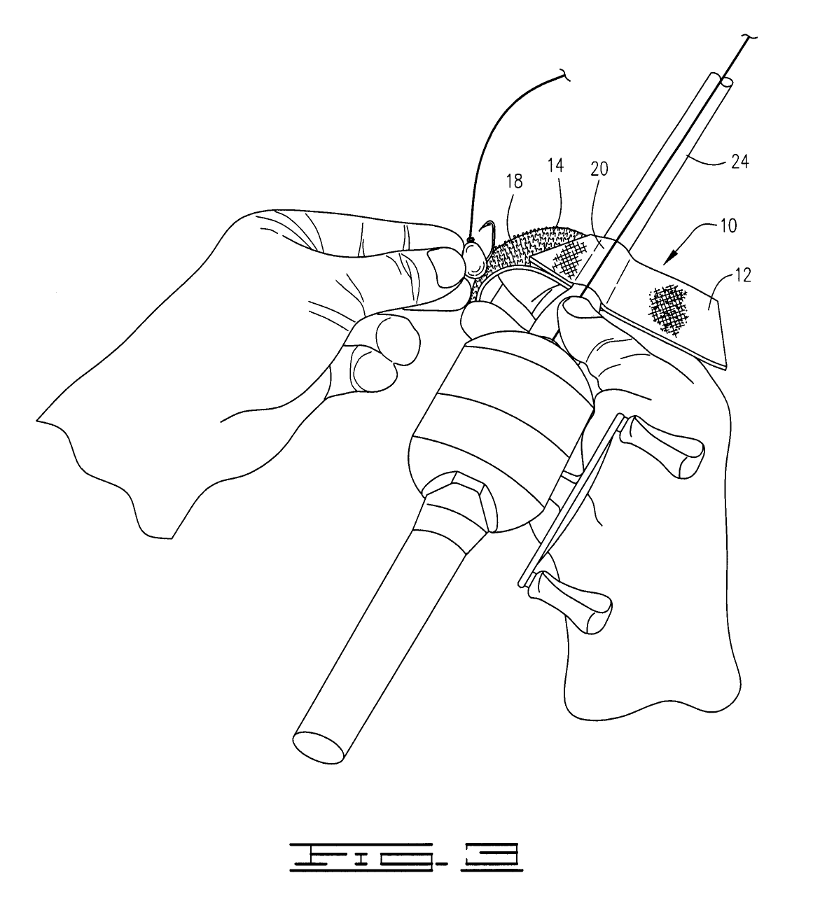

Referring now to the drawings and, more particularly to FIGS. 1 and 2, collectively shown therein is a cleaning tool 10 for fishing devices. The cleaning tool 10 includes a connector strap 12 and a cleaning strap 14. The connector strap 12 is constructed of a strip of flexible material having a looped material 16 on one side thereof. A suitable looped material is 3M Scotchgard® nylon loop (SJ3401). On the opposing side, the connector strap 12 may be printed with instructional or advertising indicia 17. A glow-in-the-dark ink may be used to facilitate use of the cleaning tool 10 in poor light conditions. The connector strap 12 may be constructed of any suitable length, but preferably has a length of approximately four inches.

The cleaning strap 14 is constructed of a strip of flexible material provided with a hook material 18 on one side thereof. A suitable hook material is 3M Scotchgard® nylon hook (SJ3402). Like the connector strap 12, the cleaning strap 14 may be constructed of any suitable length, but preferably has a length of approximately four inches.

One end of the cleaning strap 14 is connected to the connector strap 12 at or along an intermediate portion of the connector strap 12 with the hooked material 18 and the looped material 16 in a face-to-face relationship so that the portion of the connector strap 12 overlapping the cleaning strap 14 defines a loop portion 20 which is able to be looped about a portion of a fishing rod to secure the cleaning tool 10 thereabout. The remaining portion of the connector strap 12 defines an extension portion 22. The cleaning strap 14 may be connected to the connector strap 12 in any suitable manner, such as by sewing or with an adhesive or mechanical fastener.

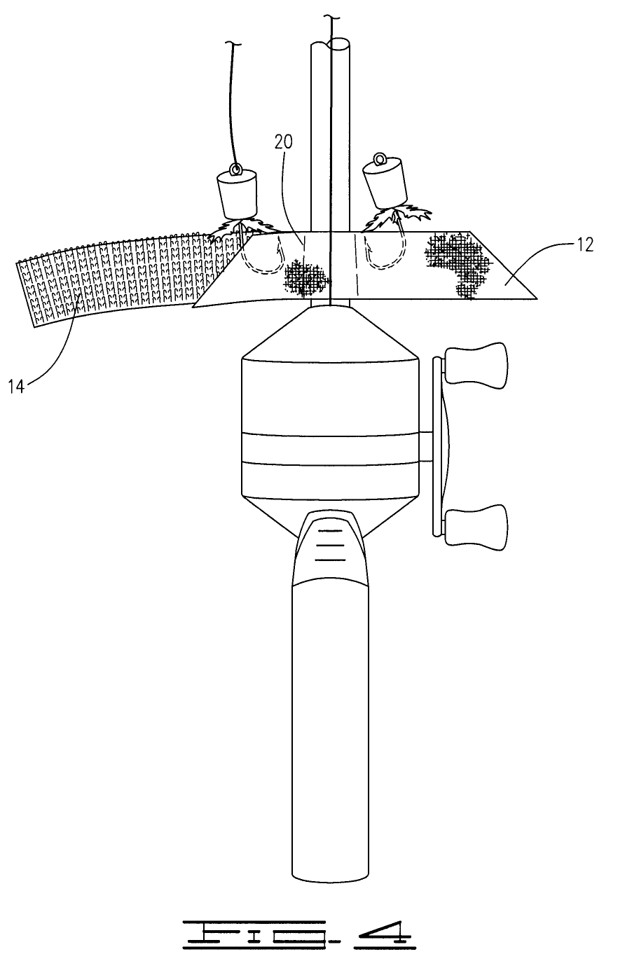

To attach the cleaning tool 10 to a fishing rod 24 (FIG. 3) for right-hand operation, the connector strap 12 is separated from the cleaning strap 14 and the fishing rod 24 is positioned between the loop portion 20 of the connector strap 12 and the cleaning strap 14 with the cleaning strap 14 extending to the left-hand side of the fishing rod and the hook material 18 facing upward. The loop material 16 of the connector strap 12 is then pressed against the hook material 18 of the cleaning strap 14 thereby securing the cleaning tool 10 about the fishing rod. For left-hand operation, the process is identical except the cleaning strap 14 is extended from the right-hand side of the fishing rod.

In use, hooks and fishing lures, including bearings, blade swivels, and other inaccessible moving parts, are cleaned using the exposed hook material 18 of the cleaning strap 14. The lure or hook is simply held in one's left hand and the hook material 18 of the cleaning strap 14 is brushed against the fishing lure, as illustrated in FIG. 3. Alternatively, one may brush the fishing lure against the hook material 18 of the cleaning strap 14.

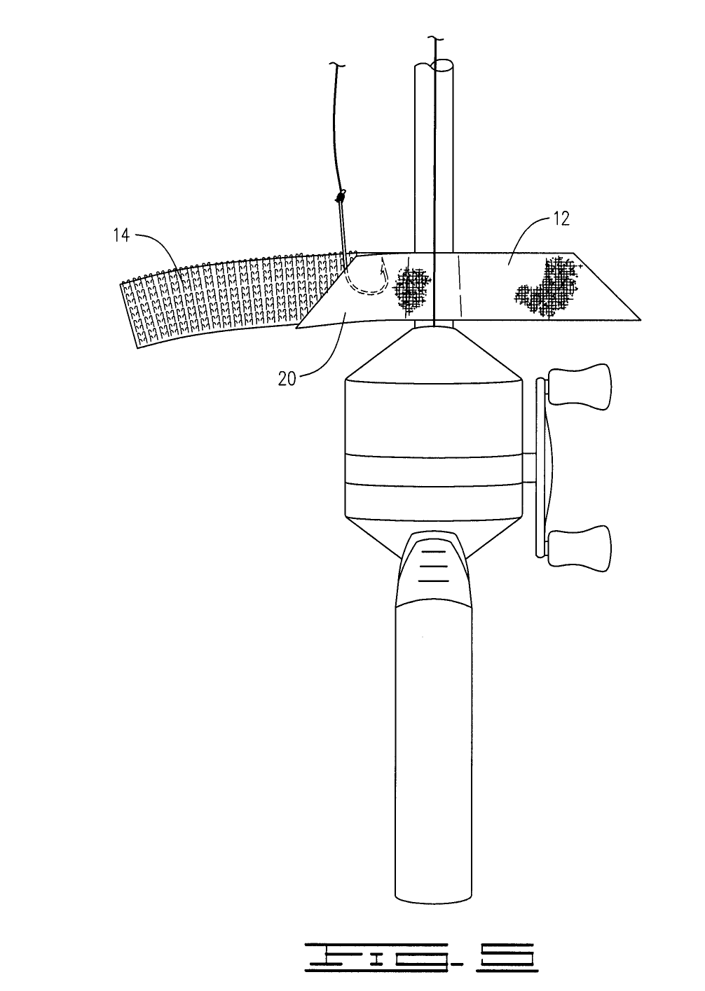

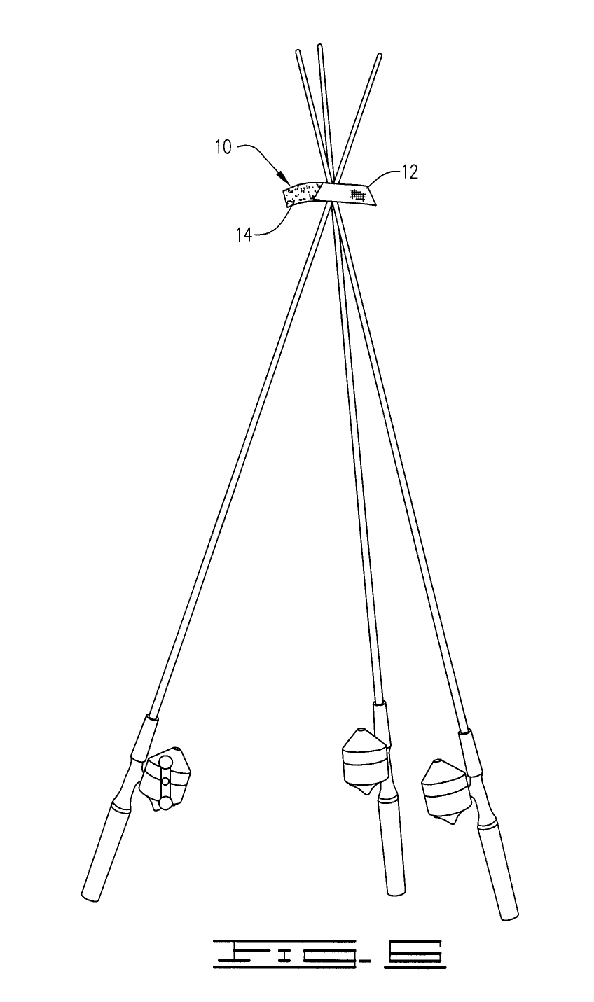

The cleaning tool 10 may also be used to secure lures, hooks, or line, to the fishing rod for transportation, as shown in FIG. 4. To do so, the loop portion 20 of the connector strap 12 is separated from the cleaning strap 14 and the lure or line is inserted between the connector strap 12 and the cleaning strap 14. The loop portion 20 of the connector strap 12 is then reattached to the cleaning strap 14 thereby securing the lure or line. Hooks may additionally be stored using the cleaning tool 10 by inserting the hooks between the connector strap 12 and the cleaning strap 14 when the connector strap 12 is connected to the cleaning strap 14 (see FIG. 5). Additional lures may be stored by entangling the hook points between the cleaning strap 14 and the extension portion 22 of the connector strap 12.

To store multiple rods during transportation, the cleaning strap 14 is encircled about the rods, preferably about two-thirds of the way up the rods, and the extension portion 22 of the connector strap 12 is secured to the cleaning strap 14, thereby securing the cleaning tool 10 about the fishing rods (see FIG. 6).

From the above description it is clear that the present invention is well adapted to carry out the objects and to attain the advantages mentioned herein as well as those inherent in the invention. While presently preferred embodiments of the invention have been described for purposes of this disclosure, it will be understood that numerous changes may be made which will readily suggest themselves to those skilled in the art and which are accomplished within the spirit of the invention disclosed and as defined in the appended claims.

What is claimed is:

1. A cleaning tool for fishing lures, comprising:
a connector member having a top surface and a bottom surface, the bottom surface comprising a fastening portion; and
a cleaning member having a top surface comprising a fastening portion and a cleaning portion, the cleaning portion having a plurality of cleaning tines;
wherein the fastening portion of the cleaning member is placed in face-to-face relationship with the fastening portion of the connector member and at least a portion of a fishing rod is positionable between the fastening portion of the cleaning member and the fastening portion of the connector member, such that when the cleaning member and the connector member are pressed together the cleaning tool is secured to at least a portion of the fishing rod, and
wherein when a fishing lure is brought into contact with the cleaning tines of the cleaning member, the cleaning tines remove debris disposed on the fishing lure.

2. The cleaning tool of claim 1, wherein the top surface of the connector member comprises an advertising indicia.

3. The cleaning tool of claim 1, wherein the fastening member of the connector member comprises a series of loops and the fastening member of the cleaning member comprises a series of hooks, the series of loops of the fastening member of the connector member are constructed to adjoin with the series of hooks of the fastening member of the cleaning member about at least a portion of the fishing rod disposed therebetween to secure the cleaning tool to the fishing rod.

4. The cleaning tool of claim 1, wherein the fastening portion of the cleaning member is offset from the fastening portion of the connector member such that a portion of both the fastening member of the cleaning member and the fastening member of the connector member are exposed such that they may be utilized to secure at least a portion of an artificial bait therebetween.

5. The cleaning tool of claim 4, wherein a hook point of the artificial bait is securable between the exposed portions of the fastening member of the cleaning member and the fastening member of the connector member.

6. A cleaning tool for fishing lures, comprising:
a connector strap having a first end and a second end spaced apart from one another to define an intermediate portion and a bottom surface having a plurality of loops disposed along a length of bottom surface of the connector strap;
a cleaning strap comprising a first end and a second end spaced apart from one another to define an intermediate portion, the top surface having a plurality of hooks disposed along a length of top surface of the cleaning strap, the plurality of hooks constructed to adjoin with the plurality of loops of the connector strap; and
wherein the connector strap and the cleaning strap are fixedly attached to one another by positioning the bottom surface of the connector strap in a face-to-face relationship with the top surface of the cleaning member and fixedly securing the first end of the cleaning strap to the connector strap at any point along the intermediate portion of the cleaning strap so as to form a loop portion between the connector strap and the cleaning strap;
wherein the cleaning tool is securable about a fishing rod by disposing at least a portion of the fishing rod within the loop portion formed between the connector strap and the cleaning strap and releaseably connecting the first end of the connector strap at any point along the intermediate portion of the connector strap, and
wherein when a fishing lure is brought into contact with the plurality of hooks disposed on the second end of the cleaning member, the plurality of hooks operate to remove debris disposed on the fishing lure.

7. The cleaning tool of claim 6, wherein an additional fishing device may be disposed and secured between the second end of the connector strap and the first end of the cleaning strap by positioning the second end of the connector strap and the first end of the cleaning in a face-to-face relationship and disposing at least a portion of the additional fishing device therebetween and pressing the second end of the connector strap and the first end of the cleaning strap together.

8. A cleaning tool in combination with a fishing rod, the cleaning tool comprising:
a connector member having a top surface and a bottom surface, the bottom surface comprising a fastening portion; and
a cleaning member having a top surface comprising a fastening portion and a cleaning portion, the cleaning portion having a plurality of cleaning tines;
wherein the fastening portion of the cleaning member is in a face-to-face relationship with the fastening portion of the connector member with at least a portion of the fishing rod positioned between the fastening portion of the cleaning member and the fastening portion of the connector member, the cleaning member and the connector member being secured to one another such that the cleaning member is secured to at least a portion of the fishing rod, and
wherein when a fishing lure is brought into contact with the cleaning tines of the cleaning member, the cleaning tines remove debris disposed on the fishing lure.

9. The cleaning tool of claim 8, wherein the top surface of the connector member comprises an advertising indicia.

10. The cleaning tool of claim 8, wherein the fastening member of the connector member comprises a series of loops and the fastening member of the cleaning member comprises a series of hooks, the series of loops of the fastening member of the connector member are constructed to adjoin with the series of hooks of the fastening member of the cleaning member about at least a portion of fishing device disposed therebetween.

11. The cleaning tool of claim 8, wherein a hook point of an artificial bait is securable between a portion of the top surface of the cleaning member and portion of the bottom surface of the connector member.
